(19) United States
(12) Patent Application Publication
(10) Pub. No.: US 2026/0138565 A1
(43) Pub. Date: May 21, 2026

(54) WINDSHIELD HEATER GRID

(71) Applicant: Tesla, Inc., Austin, TX (US)

(72) Inventors: Aditya Murthy, Dublin, CA (US); Matthew Oswald, Saratoga, CA (US)

(21) Appl. No.: 19/120,490

(22) PCT Filed: Oct. 26, 2023
(86) PCT No.: PCT/US2023/036044

§ 371 Date: Apr. 11, 2025

Related U.S. Application Data
(60) Provisional application No. 63/420,429, filed on Oct. 28, 2022.

(51) Int. Cl. B60S 1/02; H05B 3/86

(52) U.S. Cl. CPC B60S 1/026; H05B 3/86

(57) ABSTRACT

A heating grid design for vehicle windshield can include heating element that extends substantially along boundaries of fields of views of vehicle cameras. The heating element can also be arranged to extend substantially vertically across central areas of the windshield and along an outer boundary of the windshield.

### CROSS-REFERENCE TO RELATED APPLICATIONS

This application claims priority to U.S. Prov. App. No. 63/420429 titled “WINDSHIELD HEATER GRID” and filed on Oct. 28, 2022, the disclosure of which is hereby incorporated herein by reference in its entirety.

### TECHNICAL FIELD

The present application relates to a heating solution for a vehicle windshield. More particularly, the heating solution includes a heater grid embedded in the vehicle windshield.

### BACKGROUND

Vehicle windows can often become foggy or frosted when outside temperatures are low. Many vehicles provide heating solutions that heat up the vehicle windows to ensure that the drivers have a clear view through the windshield. Some vehicles implement heating elements disposed on or embedded in front and/or back windshields. However, heating elements can be visible and obstruct the view of the driver. Thus, there remains a need for an improved windshield heating system.

### SUMMARY

The disclosure relates generally to a heating solution for windshield of a vehicle. More specifically, various embodiments of this disclosure relate to a heater grid embedded in the windshield of the vehicle.

An aspect is directed to a windshield for a vehicle having one or more cameras configured to sense through the windshield. Each of the one or more cameras having a field of view on the windshield. The windshield includes an outer layer, an inner layer, an interlayer, and a heating element. The heating element is between the outer layer and the inner layer and positioned so as to extend along a boundary of the field of view for the one or more cameras and portions of a boundary of the windshield.

A variation of the aspect above is, wherein the heater element extends substantially vertically across a central area of the windshield.

A variation of the aspect above is, wherein the one or more cameras comprises a main camera, a wide camera, and/or a narrow camera.

A variation of the aspect above is, wherein the field of view comprises a main camera field of view, a wide camera field of view, and/or a narrow camera field of view.

A variation of the aspect above is, wherein the heating element does not extend across a center of the main camera field of view and a center of the narrow camera field of view.

A variation of the aspect above is, wherein the heating element comprises at least one heating wire configured to generate heat.

A variation of the aspect above is, wherein the at least one heating wire has diameter in a range of 100 micron-1 mm.

A variation of the aspect above is, wherein the heating element is coated with an anti-reflective coating.

### BRIEF DESCRIPTION OF THE DRAWINGS

The present disclosure is described with reference to the accompanying drawings, in which like reference characters reference like elements, and wherein:

FIG. 1 illustrates an example of a vehicle having a plurality of cameras.

FIG. 2A shows an example of a vehicle windshield having a conventional heater design.

FIG. 2B shows an exemplary embodiment of a windshield heater grid design according to this disclosure.

FIG. 3 illustrates a comparison of baseline images and improved images generated according to the techniques described herein.

FIG. 4 is another embodiment of a windshield heater grid design according to this disclosure.

FIG. 5A is a thermal image showing temperatures of the windshield in FIG. 2A when the heater is in use.

FIG. 5B is a thermal image showing temperatures of the windshield in FIG. 2B when the heater is in use.

FIG. 5C is a thermal image showing temperatures of the windshield in FIG. 4 when the heater is in use.

### DETAILED DESCRIPTION

Generally described, one or more aspects of the present disclosure relate to a heating solution for a windshield of a vehicle. In certain embodiments, this disclosure relates to a windshield that comprises an embedded heater grid. Certain vehicles, such as autonomous vehicles, may use image sensors to detect objects in the environments the vehicles travel in. When the image sensors are configured to sense through a windshield that has heating elements, the heating elements can cause diffraction and impact the ability of the image sensors to reliably determine nearby objects.

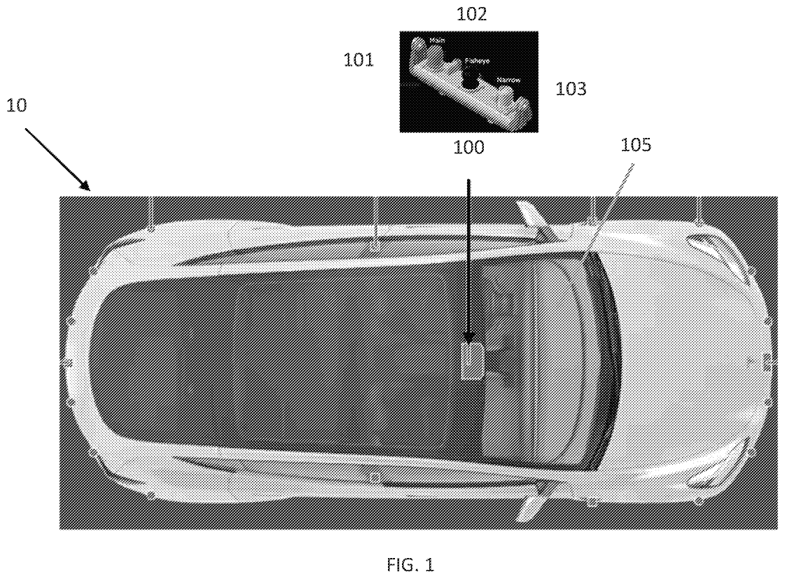

For example, in certain embodiments, a vehicle 10 can have an imaging system 100 that comprises a main camera 101, a wide camera 102 (e.g., fisheye), and a narrow camera 103 as shown in FIG. 1. In accordance with various embodiments disclosure herein, the imaging system can have any number of cameras and include any kinds of cameras. In some embodiments, the imaging system can have only one camera. In some embodiments, one or more cameras of the imaging system 100 can be visible light cameras. In some embodiments, one or more cameras of the imaging system 100 can be shortwave infrared cameras. The imaging system 100 can be disposed inside a front windshield 105 of the vehicle 10, proximate an upper edge of the front windshield 105.

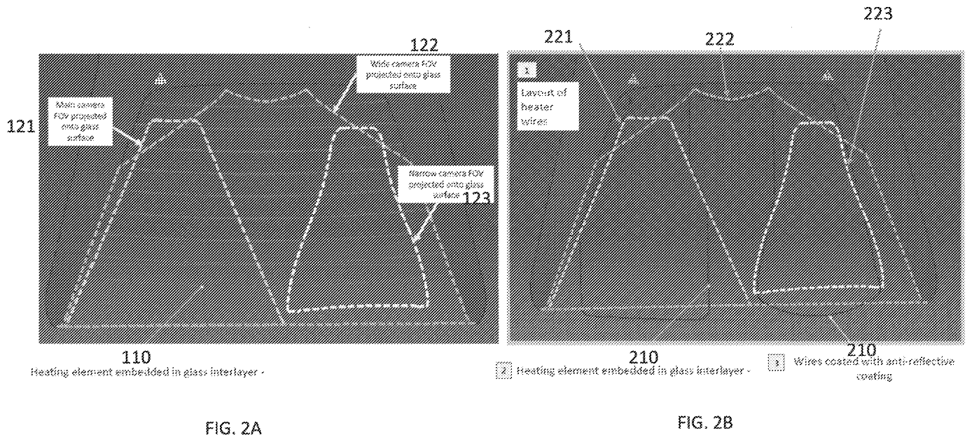

The Field of view (“FOV”) of each camera can be shown as in FIG. 2A, by projecting each field of view onto a glass surface of the windshield. In certain embodiments, the main camera 101 can have a field of view 121 covering a left portion of the windshield area. In certain embodiments, the narrow camera 123 can have a field of view 123 covering a right portion of the windshield area. In certain embodiments, the wide camera 102 can have a field of view 122 covering almost the entire windshield area except for corners proximate the wide camera 102. Each of the FOVs 121, 122, and 123 can have a certain degree of view. For example, 121 can have a FOV degree in the range of 30-90 degrees; 122 can have a FOV degree in the range of 90-160 degrees; 123 can have a FOV degree in the range of 10-80 degrees.

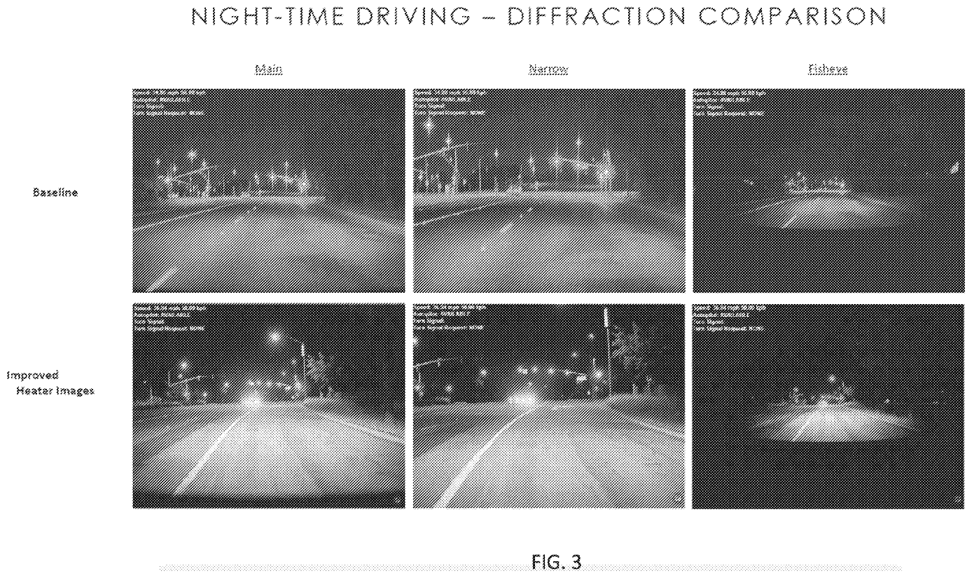

A conventional windshield heater grid design, as shown in FIG. 2A, can be implemented to have a plurality of parallel horizontal heating elements 110 embedded throughout the windshield. The heating elements 110 can include wires having a wire diameter of, for example, 180 microns. The conventional windshield heater grid 110 can provide a uniform defrost and/or defog effect as the heating elements are distributed evenly throughout the windshield. However, when the uniformly distributed heating elements 110 cross over the fields of views 121-123 at various points they cause diffraction and other artifacts in the images, shown as baseline images on the first row of FIG. 3.

A windshield heater grid design according to this disclosure can be located substantially along outer boundaries of the fields of view of the cameras such that any obstruction of view caused by the heating element can be minimized. For example, a field of view of a camera can indicate an extent to which a real-world environment is observable by a camera (e.g., the angular field of view). Thus, the boundaries of the field of view represent the boundaries of the angular field of view. As another example, a field of view of a camera can indicate a field of view at which the camera is able to resolve the real-world environment without lens distortion or without lens distortion below a threshold. For example, images from the camera may be cropped outside of the field of view to remove those portions with distortion.

In some embodiments, the heater grid design can include a heating element that extends substantially vertically across a center of a windshield and along portions of an outer boundary of the windshield. For example, the heater grid design may not include a multitude of horizontal heating elements as in FIG. 2A. For example, the heating element 210 can be located in the windshield and have a W-shape as shown in FIG. 2B.

The heating element can be embedded in an interlayer of the windshield. For example, the windshield can include an outer glass layer, one or more plastic interlayers, and an inner glass layer. In some embodiments, the heating element may be embedded in the one or more plastic interlayers. In some embodiments, the heating element can be embedded in, or coupled to, one of the inner and outer glass layers.

In some embodiments, the heating element 210 can extend substantially along a left side of the field of view 221, a bottom side of the field of view 221, a right side of the field of view 221, a top portion of the field of view 222, a left side of the field of view 223, a bottom side of the field of view 223, and a right side of the field of view 223. In some embodiments, the heating elements can include heating wires having a wire diameter (e.g., 200 microns) slightly greater than that of a conventional heating grid because of the reduced coverage of heating wires. In some embodiments, the heating wires can have a wire diameter in a range of 180-220 microns. In some embodiments, the heating wires can have a wire diameter in a range of 100 microns-1 mm. In some embodiments, the heating wires can also be coated with anti-reflective coating to further reduce any diffraction problem.

As an example, the heating element 210 (e.g., at least one heating wire) may extend substantially vertically within the field of view 221 or 223. The heating element may then extend horizontally into a different field of view (e.g., field of view 222). Field of view 222 may encompass or substantially encompass field of view 221 and 223 along with a central portion of the windshield. The heating element may be substantially proximate to, or substantially the same as, a boundary of the field of view 222. The heating element after extending horizontally, may then extend vertically into field of view 221 or 223, Thus, the heating element may extend horizontally outside of the field of view 221 or 223.

FIG. 3 shows a comparison of a set of baseline images taken from each of a main camera, a narrow camera, and a wide camera (e.g., fisheye) between a baseline condition using the conventional heater grid design and the improved imaging condition implementing the heating element 210. The improved images (the second row of FIG. 3) have reduced diffraction issues, especially around traffic lights, due to reduced obstruction from the heating elements.

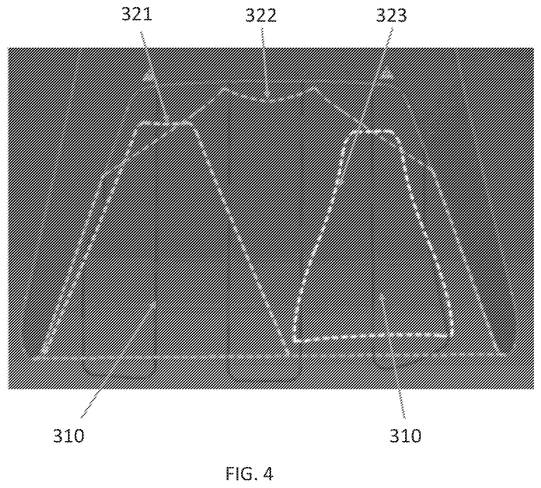

FIG. 4 shows another exemplary embodiment of the heater grid design having a heating element 310 that extends substantially vertically across a center of a windshield and along portion of an outer boundary of the windshield. For example, the heater element 310 can similarly extend substantially along a left side of the field of view 321, a bottom side of the field of view 321, a right side of the field of view 321, a top portion of the field of view 322, a left side of the field of view 323, a bottom side of the field of view 323, and a right side of the field of view 323, but additionally, extends vertically across a center of the field of view 321 and a center of the field of view 323. The slightly increased coverage of the heater element 310 can provide better defrosting and defogging effect (e.g., faster defrost or defog).

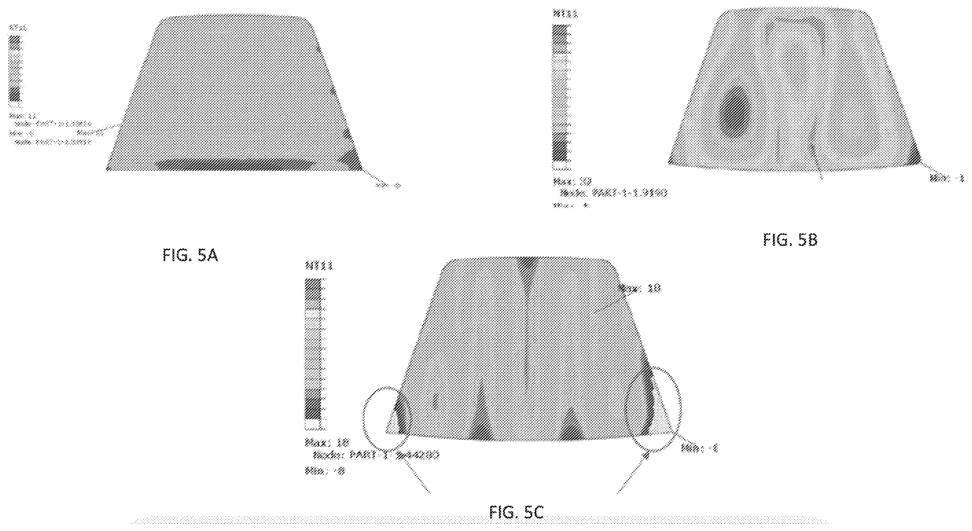

FIGS. 5A-5C are thermal images of different heater grid designs, showing how each heater grid design performs in heating the windshield.

As shown in FIG. 5A, a conventional horizontally distributed heater grid design can produce an even heating effect when in use, achieving desirable temperatures (e.g., in green and blue) over a majority of the windshield area.

As shown in FIG. 5B, a heater grid design as shown in FIG. 2B can produce a less even heating effect when in use, achieving desirable temperatures over only central areas of each field of view (e.g., main camera, narrow camera, and wide camera). With the heater grid design of FIG. 2B, although a less even heating effect may be achieved, frost or fog would still be removed in central areas to provide an unobstructed view for the driver and/or camera.

Finally, as shown in FIG. 5C, a heater grid design as shown in FIG. 4 can produce a less even heating effect when in use as compared to the conventional heater design. However, the heater grid design of FIG. 4 can achieve desirable temperatures over a majority of the windshield area due to the additional heating element across central areas of the main and narrow field of views. In some embodiments, at the desirable temperatures, fog or frost can be substantially removed (e.g., melted). In some embodiments, at the desirable temperatures, frost can be melted to an extent such that a windshield wiper can substantially remove the remaining frost.

A person having ordinary skill in the art can appreciate that a heater grid design disclosed herein can be adjusted according to various other factors, e.g., a certain camera system having different fields of views, a different number of cameras, or a different windshield shape.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed glove box actuation assembly. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including,” “comprising,” “incorporating,” “consisting of,” “have,” “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first,” “second,” “third,” “primary,” “secondary,” “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

What is claimed is:

1. A windshield for a vehicle having one or more cameras configured to sense through the windshield, each of the one or more cameras having a field of view on the windshield, the windshield comprising:
an outer layer;
an inner layer;
an interlayer; and
a heating element between the outer layer and the inner layer and positioned so as to extend substantially along a boundary of a portion of the field of view for the one or more cameras and portions of a boundary of the windshield.

2. The windshield of claim 1, wherein the heater element extends substantially vertically across a central area of the windshield.

3. The windshield of claim 1, wherein the one or more cameras comprise a main camera, a wide camera, and/or a narrow camera. 4. The windshield of claim 1, wherein the field of view comprises a main camera field of view, a wide camera field of view, and/or a narrow camera field of view.

5. The windshield of claim 4, wherein the heating element does not extend across a center of the main camera field of view and a center of the narrow camera field of view.

6. The windshield of claim 4, wherein the heating element does not extend horizontally across a center of the main camera field of view and a center of the narrow camera field of view.

7. The windshield of claim 1, wherein the heating element comprises at least one heating wire configured to generate heat.

8. The windshield of claim 6, wherein the at least one heating wire has diameter in a range of 100 micron-1 mm.

9. The windshield of claim 6, wherein the at least one heating wire has a diameter in a range of 180-220 mm.

10. The windshield of claim 1, wherein the heating element is coated with an anti-reflective coating.

11. The windshield of claim 1, wherein the heating element forms a W shape.

12. The windshield of claim 1, wherein the windshield does not include horizontal heating wires.

13. The windshield of claim 1, wherein the heating element comprises at least one heating wire, and wherein the at least one heating wire extends substantially vertically within a field of view for a particular camera of the one or more cameras.

14. The windshield of claim 13, wherein outside of the field of view for the particular camera, the at least one beating wire extends horizontally into a different field of view of a different camera.

15. The windshield of claim 1, wherein the cameras include a plurality of cameras, and wherein a first camera has a first field of view which encompasses a left-portion of the windshield, a second camera has a second field of view which encompasses a right-portion of the windshield, and a third camera has a third field of view which substantially encompasses a center-portion of the windshield along with the left-portion and right-portion of the windshield, and wherein the heating element extends horizontally proximate to an upper or lower boundary of the center-portion.
